(19) United States
(12) Patent Application Publication
(10) Pub. No.: US 2014/0152587 A1
(43) Pub. Date: Jun. 5, 2014

(54) IMAGE ADJUSTMENT SYSTEM FOR APPLICATIONS OF HANDHELD DEVICE AND METHOD THEREOF

(71) Applicants: INVENTEC (PUDONG) TECHNOLOGY CORPORATION, Shanghai (CN); INVENTEC CORPORATION, Taipei City (TW)

(72) Inventor: Liang Zhao, Shanghai (CN)

(73) Assignees: INVENTEC CORPORATION, Taipei City (TW); INVENTEC (PUDONG) TECHNOLOGY CORPORATION, Shanghai (CN)

(21) Appl. No.: 13/794,132

(22) Filed: Mar. 11, 2013

(30) Foreign Application Priority Data
Nov. 30, 2012 (CN) 201210507337.2

(51) Int. Cl. G06F 3/041

(52) U.S. Cl. CPC G06F 3/041
USPC 345/173

(57) ABSTRACT

An image adjustment system for applications of handheld devices and the method thereof are provided. An operating radius of click operation or sliding operation is received on a touch display device. The operating radius greater than or equal to a default radius is stored in a first log. The operating radius less than the default radius is stored in a second log. When the number of the first log or the second log is greater than a default number, the images displayed on the touch display device are adjusted base on a first default setting or a second default setting. Therefore, the invention achieves the effect of image adjustment for applications.

### BACKGROUND OF THE INVENTION

1. Field of Invention

The invention relates to an image adjustment system and method thereof. In particular, the invention relates to an image adjustment system for applications of handheld devices and the method thereof.

2. Related Art

Developments and applications in handheld devices transpire rapidly. Their history goes from early mobile phones and personal digital assistants (PDA's) to tablet computers and modern smartphones. And convenience has made the people's daily life inseparable from the handheld devices.

Early handheld devices were controlled or operated by means of keys thereon. But the keys occupy space, which indirectly limits the size of the display screen of the handheld device.

Presently, because of developments in touch panel technology, existing handheld devices (e.g., tablet computers and smartphones) have got rid of their dependence of controls and operations via keys. This also enables the handheld devices to use wider touch display devices (touch screens). So users can more easily operate the handheld devices.

Applications running on handheld devices provide image icons and buttons for users to operate the applications. However, the sizes of these images are pre-set by the applications and do not have different settings for different users. The user can only passively accept the pre-set image size of the applications. When the image size provided by the application is too small, the user cannot correctly click the image. When the image size provided by the application is too large, the content displayed in the application is affected. This will cause the user inconvenience in operating the handheld device and thus reduce the operating efficiency.

In summary, the prior art always has the problem that the image size provided by the handheld devices cannot be changed. It is necessary to provide an improved technical means to solve this problem.

### SUMMARY OF THE INVENTION

In view of the fact that the prior art has the problem that the handheld device applications can not change image size, causing inconvenience for users, the present invention discloses an image adjustment system for applications of a handheld device and the and method thereof

According to the disclosed system, a handheld device has a touch display device. Applications are run on the handheld device and displayed on the touch display device. The system comprises: a receiving module, a comparison module, a recording module, and an adjustment module.

The receiving module receives an operating radius of click operation or sliding operation on the touch display device. The comparison module compares the operating radius with a default radius. The recording module records the operating radius greater than or equal to the default radius in a first log and the operating radius less than default radius in a second log. The adjustment module adjusts the images shown by applications according to a default setting when the number of operating radii recorded in the first log or the second log exceeds a predetermined number.

According to the disclosed method, a handheld device has a touch display device and applications are run on the handheld device and displayed on the touch display device. The method includes the following steps.

First, the touch display device receives an operating radius of a click operation or sliding operation. Afterwards, the operating radius is compared with a default radius. When the operating radius is greater than or equal to the default radius, the operating radius is recorded in a first log. When the number of the radius data recorded in the first log exceeds a preset number, a first default setting is used to adjust the images displayed by the application. When the operating radius is smaller than the default radius, the operating radius is recorded in the second log. Finally, when the number of operating radius data recorded in the second log exceeds a preset number, a second default setting is used to adjust the images displayed by the application.

The disclosed system and method differ from the prior art in that the touch display device receives the operating radius of a click or sliding operation. When the operating radius is greater than or equal to the default radius, the operating radius is recorded in the first log. When the operating radius is less than the default radius, the operating radius is recorded in the second log. When the number of the operating radius data recorded in the first log or the second log exceeds the preset value, the first default setting or the second default setting is used to adjust the images displayed by the application.

The disclosed technical means achieves the goal of adjusting images of applications on the handheld device.

### BRIEF DESCRIPTION OF THE DRAWINGS

The invention will become more fully understood from the detailed description given herein below for illustration purposes only, and thus is not limitative of the present invention, wherein:

FIG. 1 is a block diagram of the disclosed image adjustment system for applications of handheld devices;

FIG. 2 is a flowchart of the disclosed image adjustment method for applications of handheld devices.

FIG. 3 is a schematic view of the content of the touch display device according to the invention.

FIG. 4A is a schematic view of the content in the first log according to the invention.

FIG. 4B is a schematic view of the content in the second log according to the invention.

FIGS. 5A and 5B are schematic views of image adjustment in the applications of handheld devices according to the invention.

### DETAILED DESCRIPTION OF THE INVENTION

The present invention will be apparent from the following detailed description, which proceeds with reference to the accompanying drawings, wherein the same references relate to the same elements.

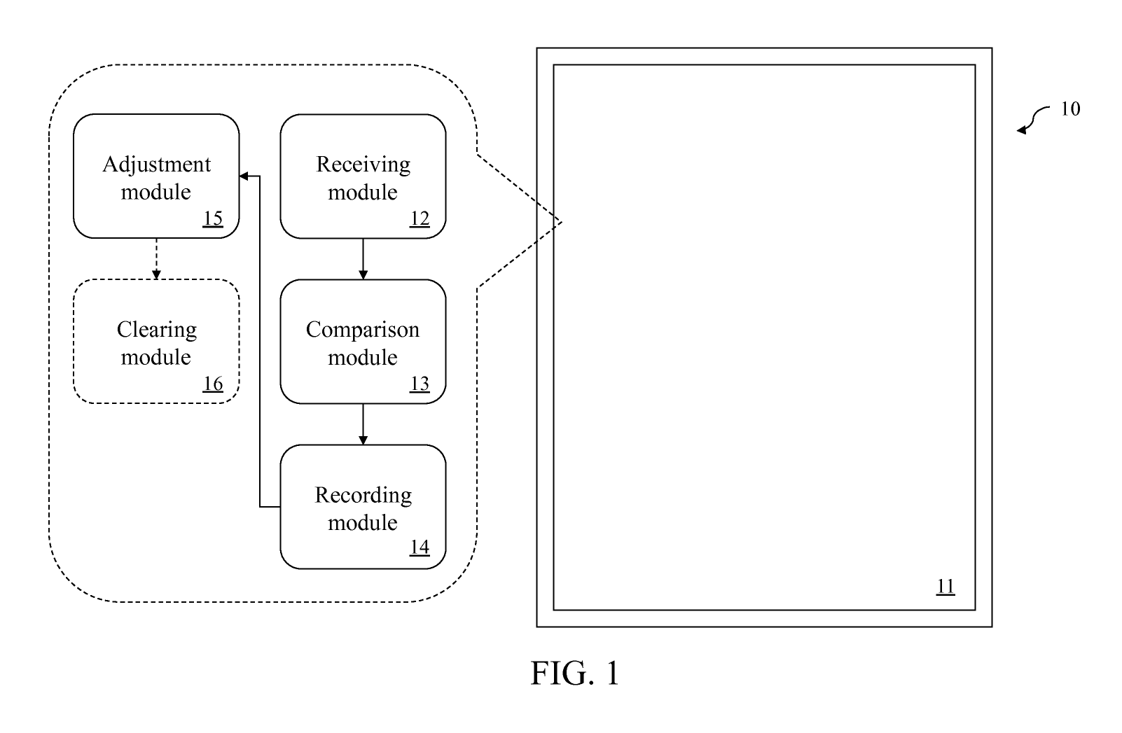

The following paragraphs first explain the disclosed adjustment system for applications on a handheld device. FIG. 1 is a system block diagram of adjustment system for applications on a handheld device according to the invention.

According to the disclosed adjustment system for applications on a handheld device, the handheld device 10 can be a smartphone, tablet PC, etc. The invention is not limited to such examples. The handheld device 10 has a touch display device 11, a receiving module 12, a comparison module 13, a recording module 14, and an adjustment module 15.

The user first runs an application on the handheld device 10. The application is displayed on the touch display device 11 of the handheld device 10. When the user performs a click or sliding operation on the touch display device 11 of the handheld device 10, the receiving module 12 of the handheld device 10 receives the operating radius from the touch display device 11 of the handheld device 10.

Take the smartphone running iOS as an example. The click operation can be regarded as a circular shape. The receiving module 12 of the handheld device 10 uses the “UIEvent” function provided by the iOS to extract the “pathMajorRadius” attribute, thereby obtaining the radius “MajorRadius” (i.e., operating radius) of the circular area generated by the click operation. The present invention is not limited to this. Smartphones running Android or Windows Phone 7/8 operating systems also have similar functions.

After the receiving module 12 of the handheld device 10 receives the operating radius of the click or sliding operation from the touch display device 11 of the handheld device 10, the comparison module 13 of the handheld device 10 compares the operating radius with a default radius. When the comparison module 13 of the handheld device 10 finds that the operating radius is greater than or equal to the default radius, the recording module 14 of the handheld device 10 records the operating radius in the first log. When the comparison module 13 of the handheld device 10 finds that the operating radius is smaller than the default radius, the recording module 14 of the handheld device 10 records the operating radius in the second log.

Each time the users clicks or slides on the touch display device 11 of the handheld device 10, the receiving module 12 of the handheld device 10 receives the operating radius of the click or sliding operation on the touch display apparatus 11 of the handheld device 10. The comparison module 13 of the handheld device 10 compares the operating radius with the default radius. According to the comparison result, the operating radius is recorded by the recording module 14 in the first log or the second log. That is, the first log and the second log have a plurality of operating radius data.

When the number of operating radii recorded in the first log or the second log exceeds a preset number, the adjustment module 15 of the handheld device 10 adjusts the images displayed by the application according to a first default setting or a second default setting. The adjustment module 15 of the handheld device 10 adjusts the image sizes, which indirectly affects the number of images displayed by the application when the images are resized.

Specifically, suppose that the application displays three images (icon, button, etc.) and that the display size of each image is “10×10.” When the number of the operating radii in the first log exceeds the preset number, the adjustment module 15 of the handheld device 10 follows the first default setting to resize image size from “10×10” to “20×20.” When the size of the images of the application changes from “10×10” to “20×20,” the number of images displayed by the application reduces from 3 to 2. The above example is only illustrative, and should not be used to limit the scope of the present invention.

Suppose that the application displays three images (icon, button, etc.) and that the display size of each image is “10×10.” When the number of the operating radii in the second log exceeds the preset number, the adjustment module 15 of the handheld device 10 follows the second default setting to resize image size from “10×10” to “5×5.” When the size of the images of the application changes from “10×10” to “5×5,” the number of images displayed by the application increases from 3 to 4. The above example is only illustrative, and should not be used to limit the scope of the present invention.

In addition, the disclosed adjustment system for applications on a handheld device further has a clearing module 16. After the adjusting module 15 of the handheld device 10 adjusts the images displayed by the application according to the first default setting or the second default setting, the clearing module 16 of the handheld device 10 clears the corresponding first log or second log.

When the number of operating radii in the first log exceeds a preset number, the adjustment module 15 of the handheld device 10 follows the first default setting to resize the images displayed by the application according to the first setting. The clearing module 16 of the handheld device 10 deletes the operating radius data in the first log.

When the number of operating radii in the second log exceeds a preset number, the adjustment module 15 of the handheld device 10 follows the second default setting to resize the images displayed by the application according to the second setting. The clearing module 16 of the handheld device 10 deletes the operating radius data in the second log.

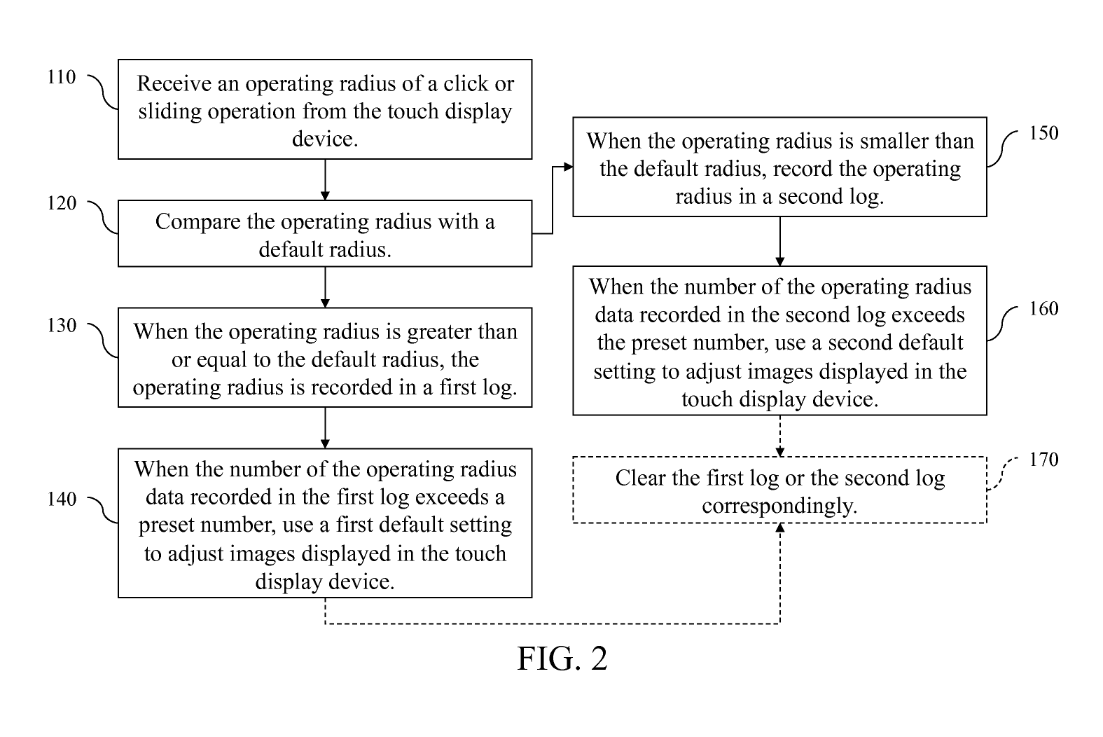

In the following, an embodiment is employed to explain the operating method and process of the present invention. The following embodiment is explained with reference to FIGS. 1 and 2. FIG. 2 is a flowchart of the disclosed image adjustment method for applications of a handheld device.

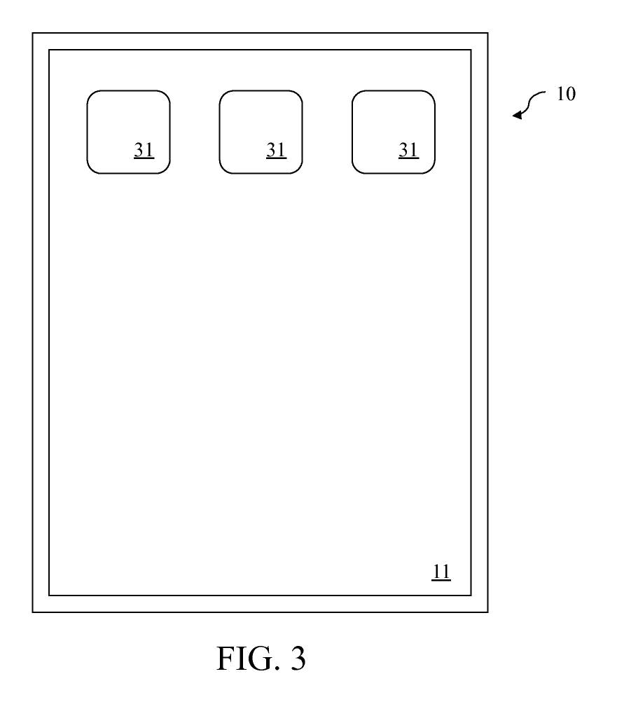

FIG. 3 is schematically shows the content of the touch display device for image adjustment in the application of the disclosed handheld device.

The user first runs an application on the handheld device 10. The application is then displayed on the touch display device 11 of the handheld device 10. Suppose that the application provides three images 31 (icon, button, etc.) and that each image 31 has a display size of “10×10.” The user clicks on the touch display device 11. Suppose that the operating radius of the click operation is “15.” The receiving module 12 of the handheld device 10 receives the operating radius of the click operation on the touch display device 11 of the handheld device 10 as “15” (step 110).

After the receiving module 12 of the handheld device 10 receives the operating radius of the click operation on the touch display device 11 of the handheld device 10 as “15,” the comparison module 13 of the handheld device 10 compares the operating radius of “15” with a default radius of “10” (the default radius being set beforehand) (step 120). In an embodiment, the comparison module 13 of the handheld device 10 finds that the operating radius of “15” is greater than the default radius of “10.”

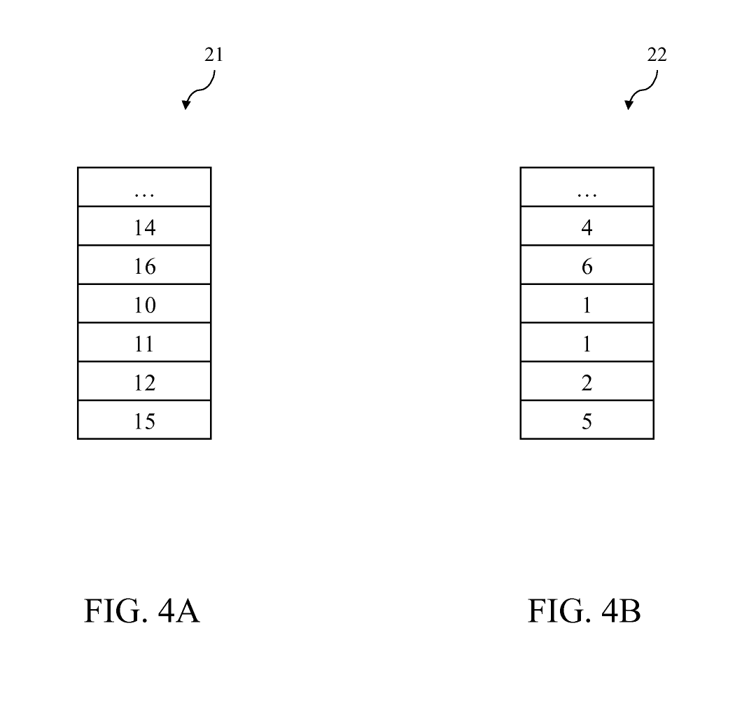

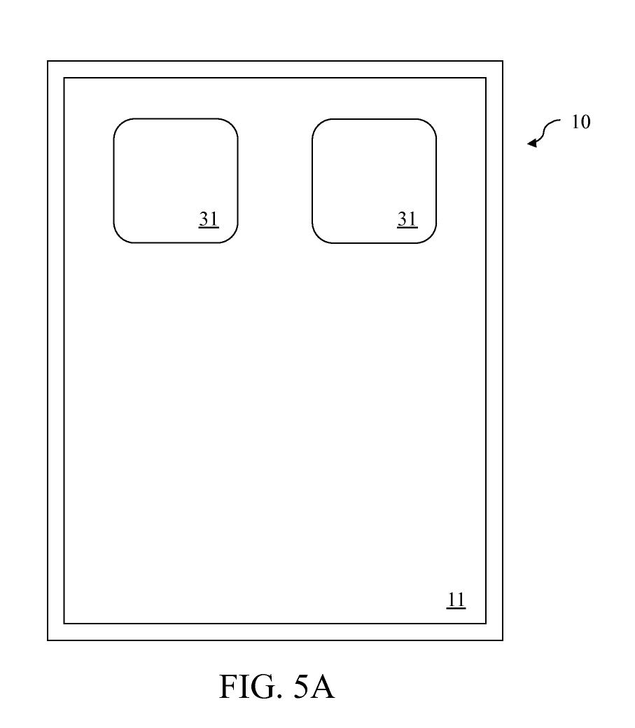

After the comparison module 13 of the handheld device 10 finds that the operating radius of “15” is greater than the default radius of “10,” the recording module 14 of the handheld device “10” records the operating radius “15” in the first log 21 (step 130). FIG. 4A shows schematically the content of the first log according to the invention.

Referring again to FIG. 3, suppose a user uses a touch pen (only an illustrative example, not meant to limit the scope of the invention) on the touch display device 11 to make a click operation. Suppose the radius of the click operation is “5,” the receiving module 12 of the handheld device 10 receives from the touch display device 11 of the handheld device 10 the operating radius of “5” (step 110).

After the receiving module 12 of the handheld device 10 receives from the touch display device 11 of the handheld device 10 the operating radius of “5,” the comparison module 13 of the handheld device 10 compares the operating radius of “5” with the default radius of “10” (the default radius being set beforehand). In this embodiment, the comparison module 13 of the handheld device 10 finds that the operation radius “5” is less than the default radius “10” (step 120).

After the comparison module 13 of the handheld device 10 determines that the operation radius “5” is less than the default radius “10,” the recording module 14 of the handheld device 10 records the operating radius “5” in the second log 22 (step 150). FIG. 4B illustrates the content of the second log according to the invention.

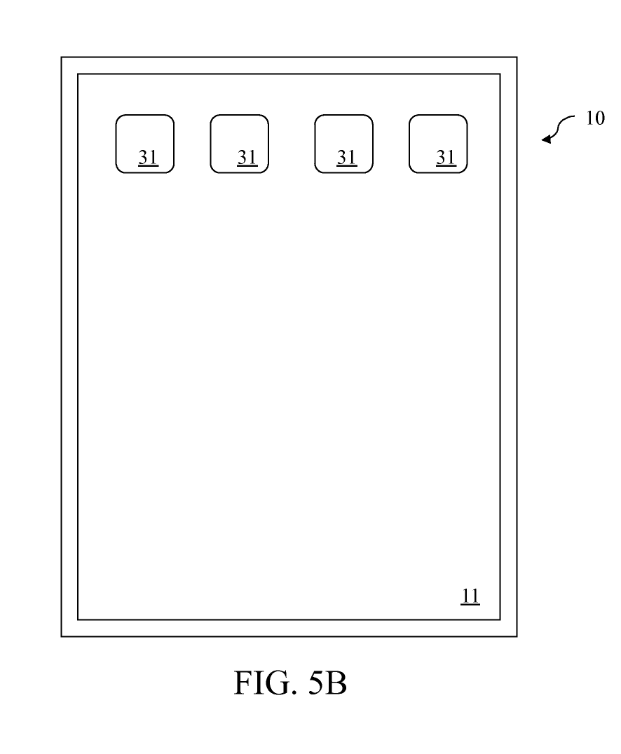

Please refer simultaneously to FIG. 4A and FIG. 5A. FIG. 5A schematically shows image adjustment in the application of a handheld device.

There are six operating radii in the first log 21. Suppose the default number is “5.” The number of the operating radii in the first log 21 already exceeds the default number “5.” The adjusting module 15 of the handheld device 10 follows the first default setting to resize the images 31 of the application from “10×10” to “20×20.” After the images 31 of the application are resized from “10×10” to “20×20,” the number of images 31 of the application changes from three to two. The adjusted result of the images 31 of the application is shown in FIG. 5A. In this case, the clearing module 16 of the handheld device 10 deletes the data of the operating radius in the first log 21.

Please refer simultaneously to FIG. 4B and FIG. 5B. FIG. 5B is a schematic view of image adjustment according to the invention.

There are six operation radii recorded in the second log 22. Suppose that the default number is “5.” Since the number of recorded radii in the second log 22 “6” is already greater than the default number “5,” the adjustment module 15 of the handheld device 10 follows the second default setting to resize the images 31 of the application from “10×10” to “5×5.” After the images 31 of the application are resized from “10×10” to “5×5,” the number of images 31 displayed by the application increases from three to four. The result of image adjustment is shown in FIG. 5B. In this case, the clearing module 16 of the handheld device 10 deletes the data of the operating radius in the second log 22.

In summary, the invention differs from the prior art in that the invention receives from the touch display device the operating radius of a click or sliding operation. When the operating radius is greater than or equal to the default radius, the operating radius is recorded in the first log. When the operating radius is less than the default radius, the operating radius is recorded in the second log. When the number of the operating radii recorded in the first log or the second log exceeds a preset number, the first default setting or the second default setting is employed to adjust the images displayed in the application.

The disclosed means can solve the problem existing in the prior art that images provided by the applications in a handheld device cannot be changed, which results in inconvenience for the user. The invention achieves the goal of image adjustment for the applications on a handheld device.

Although the invention has been described with reference to specific embodiments, this description is not meant to be construed in a limiting sense.

Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An image adjustment system for applications of a handheld device with a touch display device, the applications running on the handheld device and displaying in the touch display device, the system comprising:
a receiving module for receiving an operating radius of a click or sliding operation from the touch display device;
a comparison module for comparing the operating radius with a default radius;
a recording module for recording the operating radius in a first log when the operating radius is greater than or equal to the default radius or in a second log when the operating radius is smaller than the default radius; and
an adjustment module for using a first default setting or a second default setting to adjust images displayed in the application when the number of the operating radii recorded in the first log or the second log exceeds a preset number, respectively.

2. The image adjustment system of claim 1, wherein the operating radius is the radius of the circular area generated by the click operation.

3. The image adjustment system of claim 1 further comprising a clearing module for clearing the first log or the second log when the adjustment module uses a first default setting or a second default setting to adjust images displayed on the touch display device, respectively

4. The image adjustment system of claim 1, wherein the adjustment module adjusts the size and number of images displayed on the touch display device.

5. An image adjustment method for applications of a handheld device with a touch display device, the applications running on the handheld device and displaying in the touch display device, comprising the steps of:
receiving an operating radius of a click or sliding operation from the touch display device;
comparing the operating radius with a default radius;
recording the operating radius in a first log when the operating radius is greater than or equal to the default radius;
using a first default setting to adjust images displayed in the application when the number of the operating radii recorded in the first log exceeds a preset number;
recording the operating radius in a second log when the operating radius is smaller than the default radius; and
using a second default setting to adjust images displayed in the application when the number of the operating radius data recorded in the second log exceeds a preset number.

6. The image adjustment method of claim 5, wherein the operating radius is the radius of the circular area generated by the click operation.

7. The image adjustment method of claim 5 further comprising the step of clearing the first log or the second log after the steps of using the first default setting or the second default setting to adjust images displayed in the touch display device.

8. The image adjustment method of claim 5, wherein the steps of using the first default setting or the second default setting to adjust images displayed in the touch display device includes the adjustment of size and number of images.
